(19) United States
(12) Patent Application Publication
(10) Pub. No.: US 2004/0165155 A1
(43) Pub. Date: Aug. 26, 2004

(54) LIGHT SOURCE OF A PROJECTOR

(76) Inventors: Cheng-Kuang Lee, Taipei Hsien (TW); Ming-Kuen Lin, Yun-Lin Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/708,155

(22) Filed: Feb. 12, 2004

(30) Foreign Application Priority Data
Feb. 21, 2003 (TW) 092103716

(51) Int. Cl. G03B 21/28

(52) U.S. Cl. 353/81

(57) ABSTRACT

A light source installed in a projector for generating an enhanced light beam has a plurality of beam generators for generating light beams and a prism for deflecting the light beams to collect the light beams to form the enhanced light beam. The projector has a light pipe for uniformizing light received from the light source and an image device for processing the uniformized light from the light pipe and for projecting the processed light to form an image.

### BACKGROUND OF INVENTION

1. Field of the Invention

The present invention relates to a light source of a projector, and more particularly, to a light source having a plurality of beam generators for enhancing brightness of a projection image of a projector.

2. Description of the Prior Art

With the progress of optics, projectors have found broad use in many applications. Generally speaking, projected light intensity is usually an important factor while designing a projector, as the projection quality improves with greater intensities of the projected light.

Please refer to FIG. 1. FIG. 1 is a schematic diagram of a projector 10 according to the prior art. The projector 10 comprises a light source 12, a color wheel 14, a light pipe 16, and an image device 18. The light source 12 is used to generate a light beam 22 and to project the light beam 22 through the color wheel 14 to the light pipe 16. The color wheel 14 is positioned between the light source 12 and the light pipe 16. The color wheel 14 rotates round an axle 15 and outputs red, green, and blue polarized beams 24 by turning after filtering the light beam 22 via different filters so that the image device 18 can process the input beams according to their specific color. The light pipe 16 uniformizes the beams 24 to outputs a uniformized beam 26 to the image device 16. The image device 18 processes the uniformized beam 26 to modulate an image into the uniformized beam 26 to form an image beam 28. The image beam 28 is projected to a screen 20 to form a projection image. The light source 12 is composed of a bulb 17 for generating light and a lampshade 19 for collecting the light generated by the bulb 17 to form the light beam 22. Because the projector 10 comprises only one bulb 17 as a lighting device to provide light to the projector 10, the power of the bulb 17 should be raised when enhancing the brightness of the projection image of the projector 10. However, this method of enhancing the brightness of the projection image of the projector 10 is improper. For example, when the power of the bulb 17 is raised, the waste heat of the bulb 17 increases correspondingly, increasing the operational temperature of the projector 10. Further, if the bulb 17 becomes too hot, the bulb 17 could burn out.

### SUMMARY OF INVENTION

It is therefore a primary objective of the claimed invention to provide a light source having a plurality of beam generators for enhancing brightness of a projection image of a projector to solve the above-mentioned problem.

In an embodiment of the present invention, a light source is disclosed. The light source comprises a prism for refracting and reflecting light beams, and a plurality of beam generators. Each of the beam generators is used to generate a light beam and to project the light beam to the prism. The light beams enter the prism with a first refraction, and then leave the prism with a second refraction and are collected to form an enhanced light beam after total reflection in the prism.

In another embodiment of the present invention, another light source is disclosed. The light source comprises a prism for reflecting light beams, and a plurality of beam generators. Each of the beam generators is used to generate a light beam and to project the light beam to the prism. The light beams are reflected by the prism to form an enhanced light beam.

These and other objectives and advantages of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a projector according to the prior art.

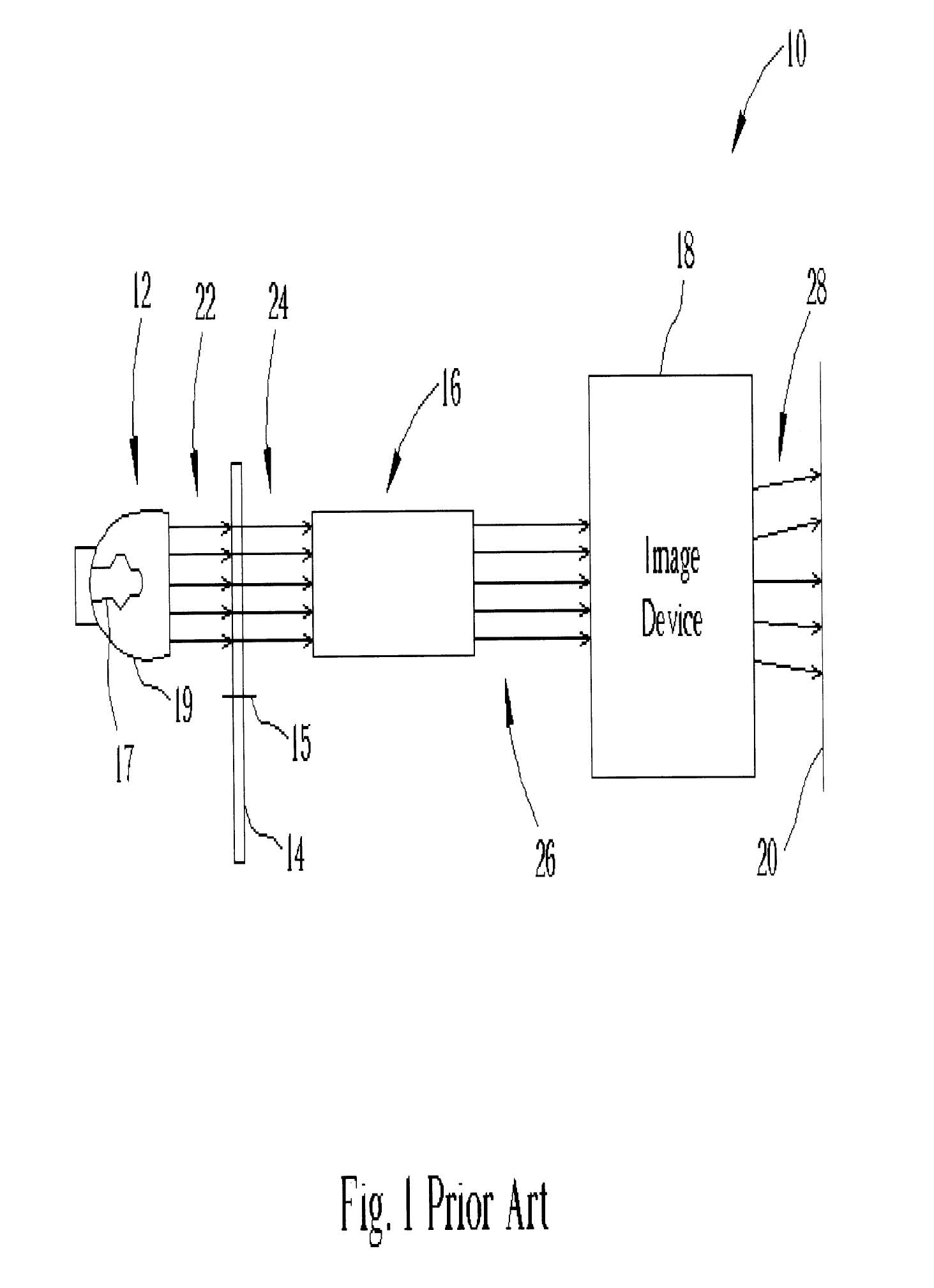

FIG. 2 is a schematic diagram of a projector using a first embodiment light source according to the present invention.

FIG. 3 is a schematic diagram of a prism of the light source shown in FIG. 2.

FIG. 4 indicates traveling paths of light beams in the prism shown in FIG. 2.

FIG. 5 is a schematic diagram of a second embodiment light source according to the present invention.

FIG. 6 is a schematic diagram of a prism of the light source shown in FIG. 5.

FIG. 7 is a schematic diagram of a third embodiment light source according to the present invention.

FIG. 8 is a schematic diagram of a prism of the light source shown in FIG. 7.

FIG. 9 is a schematic diagram of a projector using a fourth embodiment light source according to the present invention.

FIG. 10 is a schematic diagram of a fifth embodiment light source according to the present invention.

FIG. 11 is a schematic diagram of a sixth embodiment light source according to the present invention.

FIG. 12 is a schematic diagram of a projector using a seventh embodiment light source according the present invention.

FIG. 13 is a schematic diagram of the light source shown in FIG. 12.

FIG. 14 is a schematic diagram of the prism shown in FIG. 13 rotated by 60 degrees.

FIG. 15 is a schematic diagram of the prism shown in FIG. 13 rotated by 120 degrees.

FIG. 16 is a schematic diagram of the prism shown in FIG. 13 rotated by 180 degrees.

FIG. 17 is a schematic diagram of an eighth embodiment light source according to the present invention.

### DETAILED DESCRIPTION

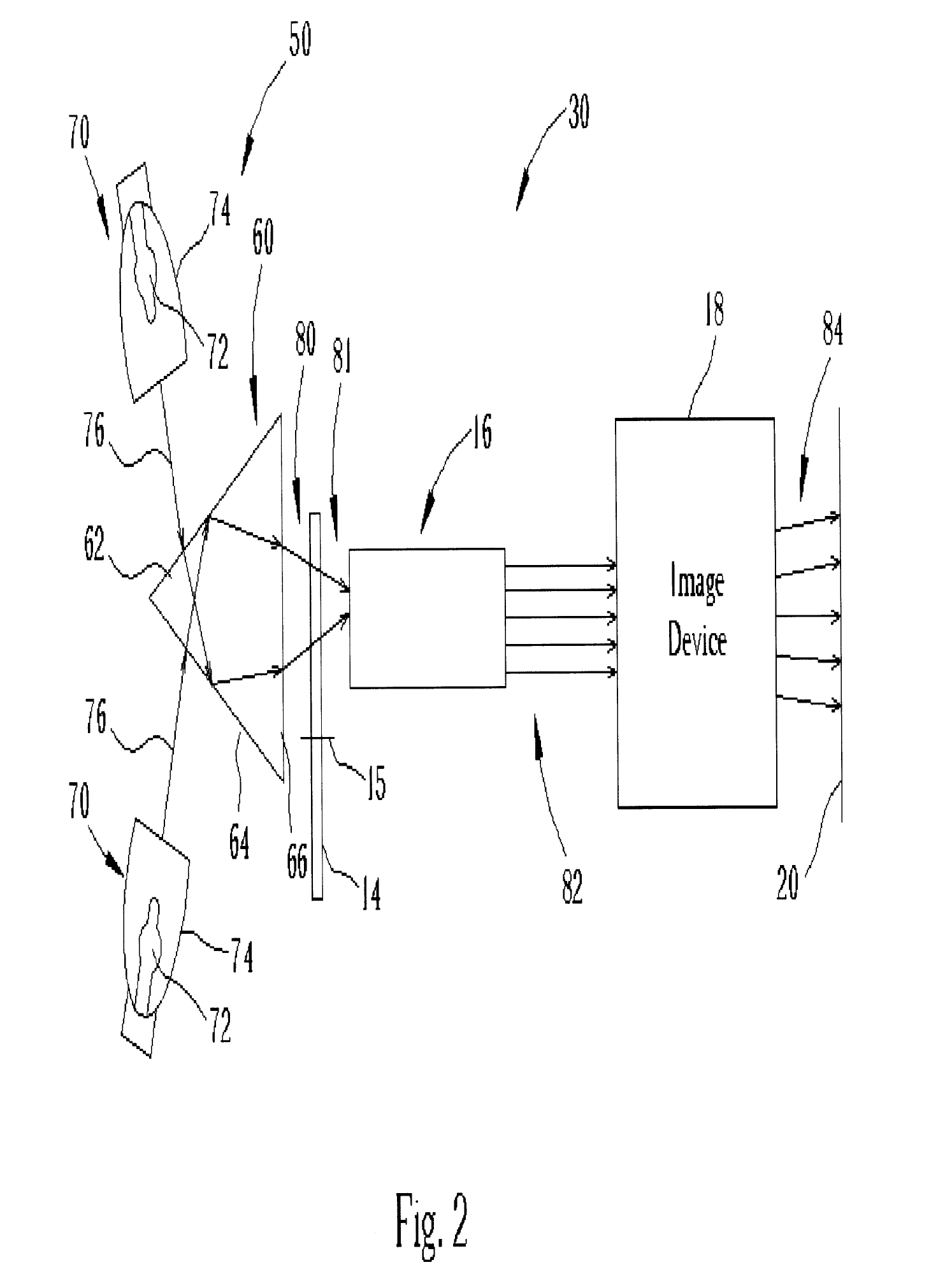

Please refer to FIG. 2, which is a schematic diagram of a projector 30 using a first embodiment light source 50 according to the present invention. The main difference between the projector 10 and the projector 30 is that the light source 50 replaces the light source 12 to provide light to the projector 30. The projector 30 also comprises a color wheel 14, a light pipe 16, and an image device 18 where the characteristics of these elements are the same as those installed in the projector 10. The light source 50 comprises a prism 60 for reflecting and refracting light, and a plurality of beam generators 70. Each of the beam generators 70 is used to generate a light beam 76 and to project the light beam 76 to the prism 60. Each of the beam generators 70 comprises a light device 72 for radiating light and a collector 74, where the light device 72 can be a bulb, a tube, or another device capable of generating light, and the light collector 74 is a parabolic mirror for collecting the light generated by the light device 72 to form the light beam 76. The prism 60 guides the light beams 76 to the light pipe 16 by refracting and totally reflecting the light beams 76 to form an enhanced light beam 80. In contrast to the prior art light source 12, if the brightness of one light beam 76 generated by one of the beam generators 70 is the same as the brightness of the light beam 22 generated by the light source 12, because the light source 50 has two of the beam generator 70, the brightness of the projection image projected by the projector 30 is greater than the brightness of the projection image projected by the projector 10. Moreover, similar to the projector 10, the color wheel 14 rotates round an axle 15 and outputs red, green, and blue beams 81 via different color filters by turning after filtering the enhanced light beam 80. The image device 18, thus, can process the input beams according to their specific color. The light pipe 16 uniformizes the beams 81 to output a uniformized beam 82 to the image device 18. The image device 18 processes the uniformized beam 82 to modulate an image into the uniformized beam 82 to form an image beam 84 and to project the image beam 84 to the screen 20 to form a projection image.

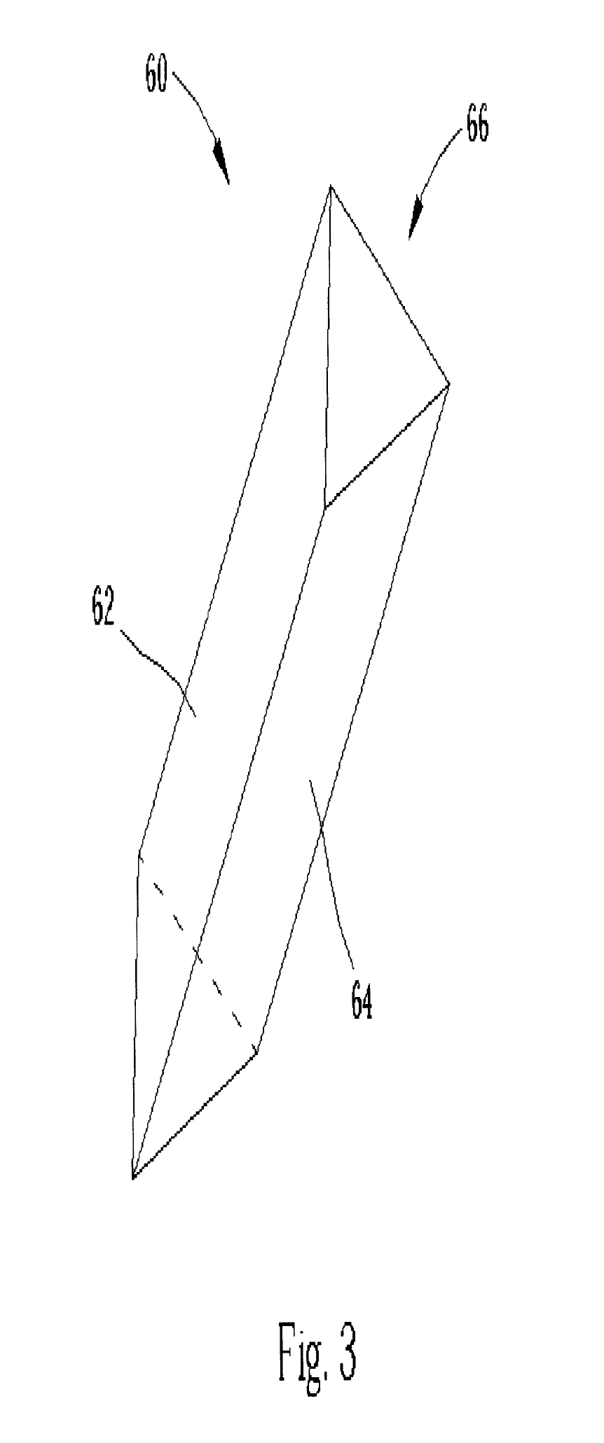

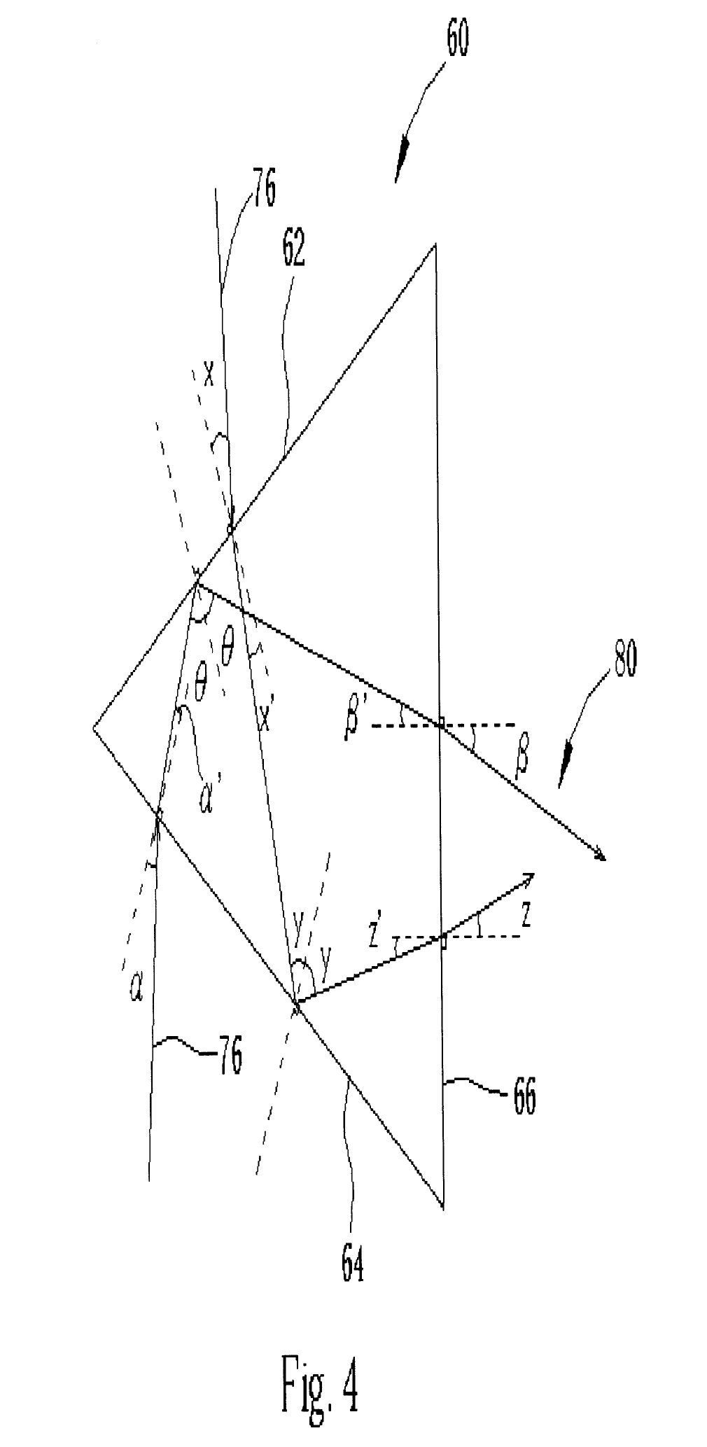

To describe the operations of the light source 50 in more detail, please refer to FIG. 2-4. FIG. 3 is a schematic diagram of the prism 60. FIG. 4 indicates traveling paths of the light beams 76. The prism 60 is made of transparent material, such as glass, and has a refractive index N1. The prism 60 comprises a first optical plane 62, a second optical plane 64, and a third optical plane 66. In this embodiment, the three optical planes 62, 64, and 66 are three rectangles having the same width and length. Two sides of each optical plane 62, 64, or 66 are respectively adjacent to the sides of the other two optical planes so that two equilateral triangles are formed at the two ends of the prism 60. The two beam generators 70 respectively face toward the first optical plane 62 and the second optical plane 64. The light beams 76 generated by the beam generators 70 enter the prism 70 respectively through the first optical plane 62 and the second optical plane 64, and then are redirected to leave the prism 60 through the third optical plane 66. When the two light beams 76 enter the prism 60, a first refraction occurs. Suppose that the refractive index of the air is N2, then incident angles α, X, and refraction angles a″, X″ have following relationship:

$$\frac{N1}{N2} = \frac{sin α}{sin {α}^{′}} = \frac{sin x}{sin {x}^{′}}$$

Because the refractive index N1 is greater than the refractive index N2, the paths of the two light beams 76 are shifted toward the normal vectors of the two optical planes 62 and 64. This means that the refraction angle α″ is less than the incident angle a and that the refraction angle X″ is less than the incident angle X. After the first refraction, the two light beams 76 are respectively totally reflected at the first optical plane 62 and the second optical plane 64 and are redirected to the third optical plane 66, where the reflection angles θ and y have following relationship:

$$sin θ \geq \frac{N2}{N1} , sin y \geq \frac{N2}{N1}$$

After the total reflection in the prism 60, the light beams 76 leave the prism 60 with a second refraction. The incident angles β″, Z″, and the refraction angles β, Z have following relationship:

$$\frac{N1}{N2} = \frac{sin β}{sin {β}^{′}} = \frac{sin z}{sin {z}^{′}}$$

Similarly, because the refractive index N1 is greater than the refractive index N2, the paths of the two light beams 76 stray from the normal of the third optical planes 66. This means that the refraction angle β is greater than the incident angle β″ and that the refraction angle z is greater than the incident angles z″. Finally, the two light beams 76 leave the prism 60 through the third optical plane 66 and then are collected to from the enhanced light beam 80.

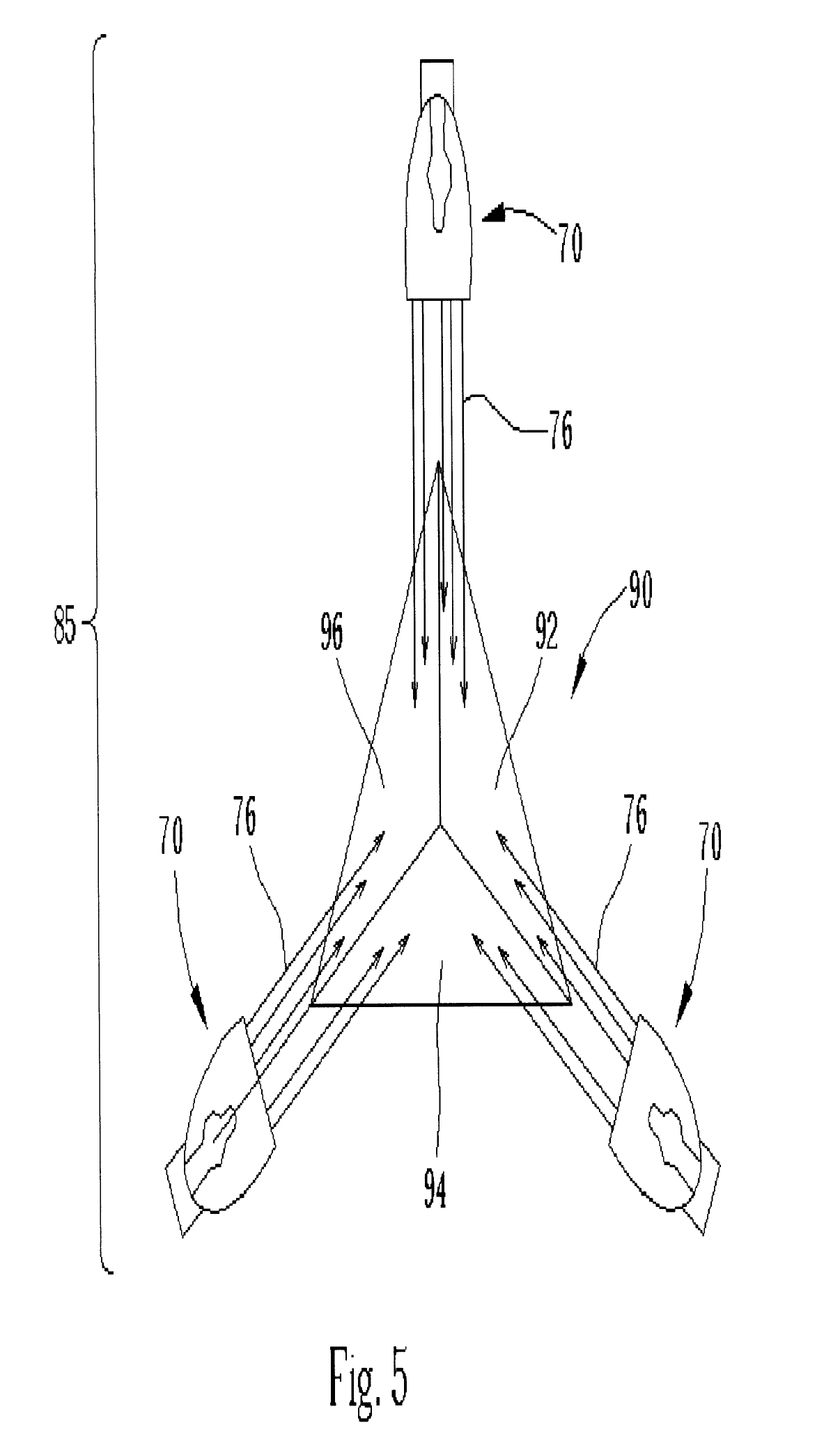

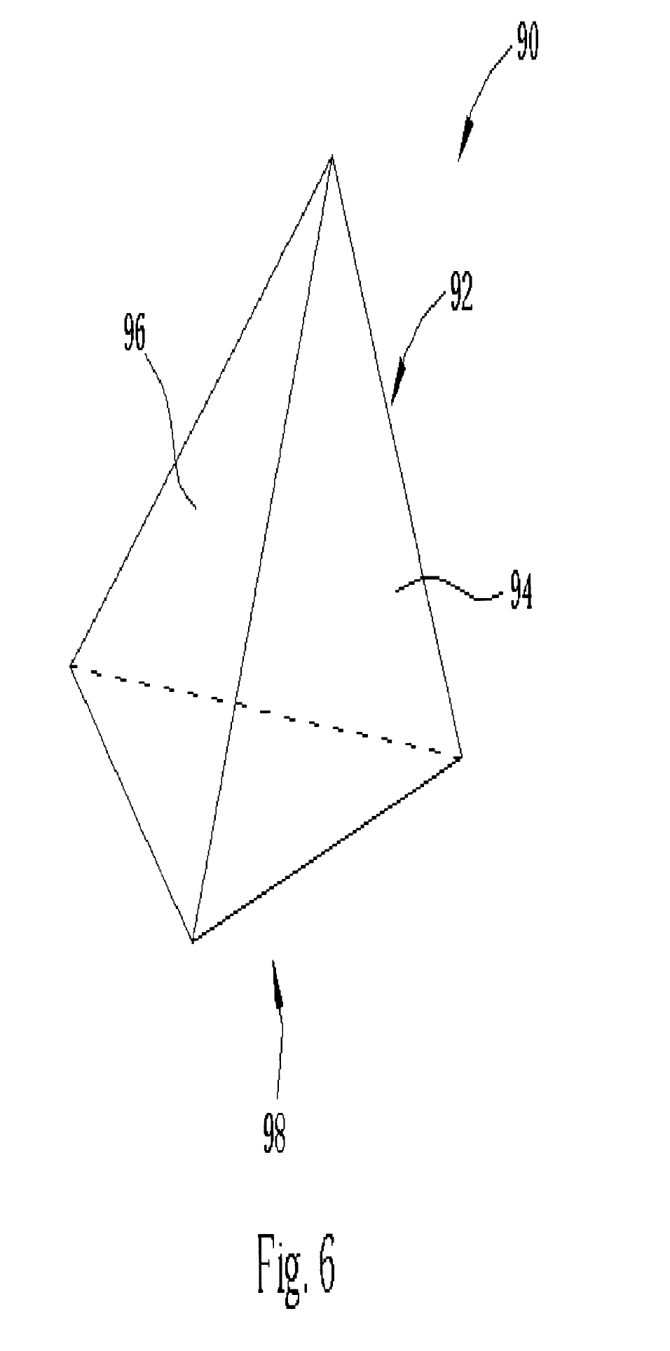

Please refer to FIG. 5 and FIG. 6. FIG. 5 is a schematic diagram of a second embodiment light source 85 according to the present invention. FIG. 6 is a schematic diagram of a prism 90 of the light source 85. Both of the two light sources 50 and 85 are used to provide light to a corresponding projector. The main differences between the two light sources 50 and 85 are the shape of their prism and the amount of beam generators 70. The prism 90 of the light source 85 comprises four equilateral triangular optical planes: a first optical plane 92, a second optical plane 94, a third plane 96, and a fourth optical plane 98. The light source 85 comprises three beam generators 70 for generating light beams 76 and for respectively projecting the light beams 76 to the first optical plane 92, the second optical plane 94, and the third optical plane 96. The three light beams 76 are respectively totally reflected at the first optical plane 92, the second optical plane 94, and the third optical plane 96, and then are emitted out from the prism 90 through a fourth optical plane 98 of the prism 90 and are collected into an enhanced light beam. Moreover, the fourth optical plane 98 is positioned toward to the image device of the projector so that the light pipe is capable of receiving light from the light source 85.

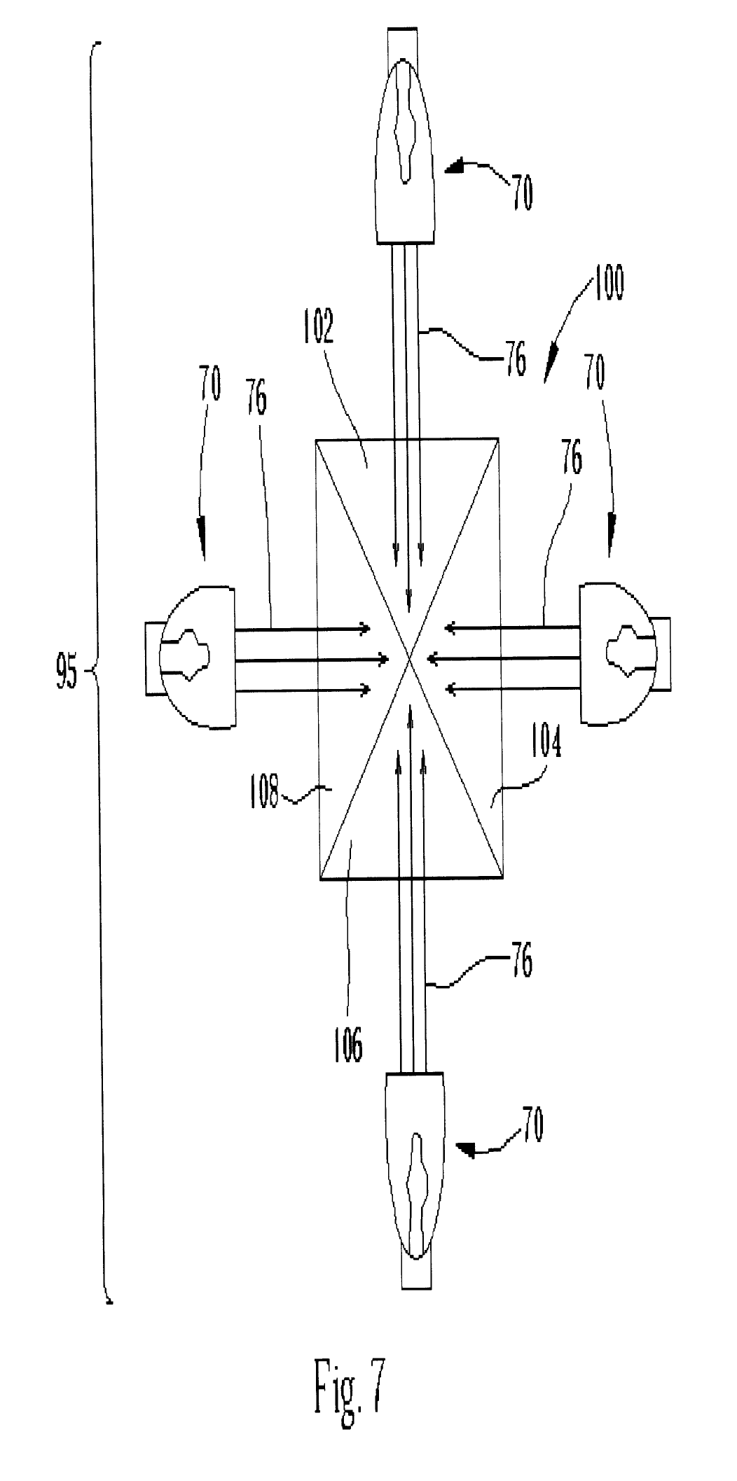

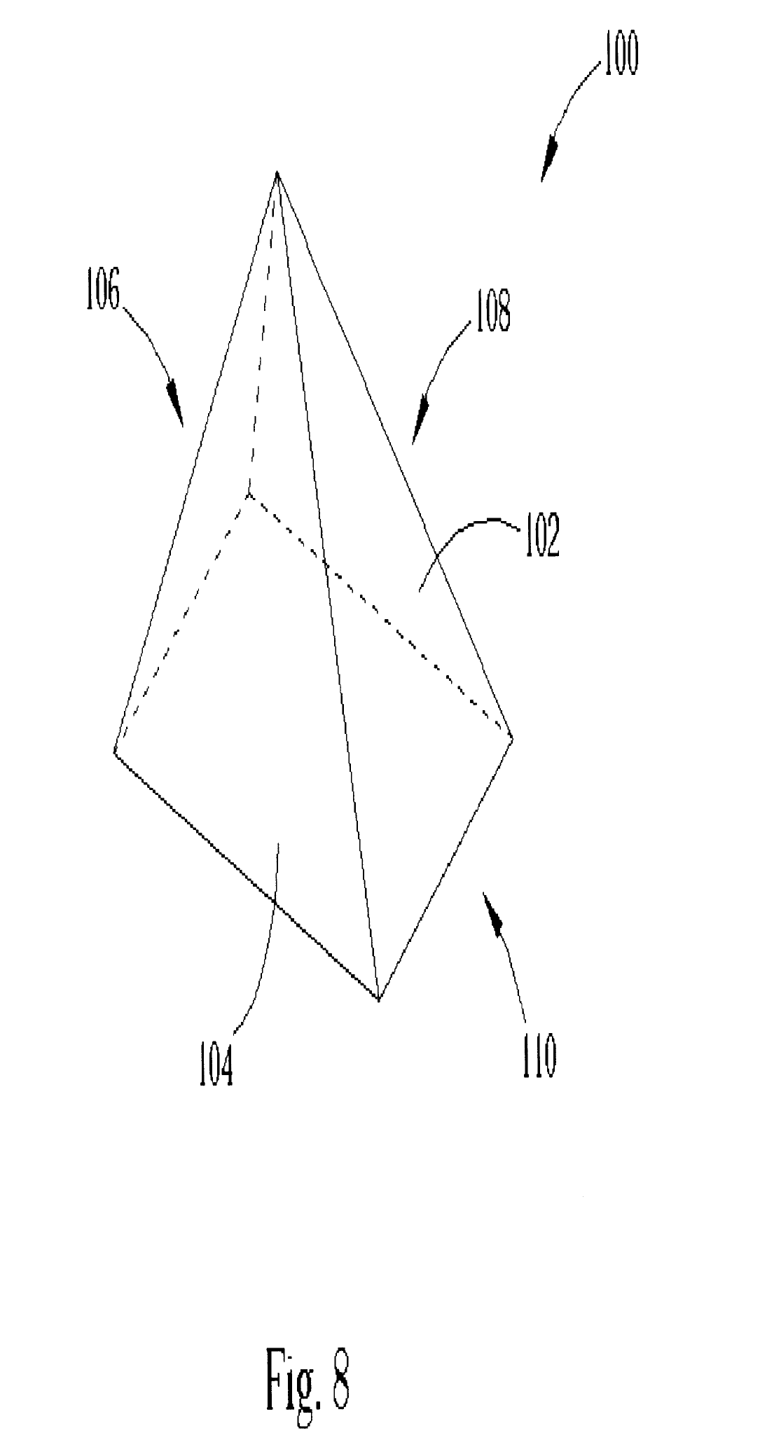

Please refer to FIG. 7 and FIG. 8. FIG. 7 is a schematic diagram of a third embodiment light source 95 according to the present invention. FIG. 8 is a schematic diagram of a prism 100 of the light source 95. The main difference between the light source 95 and the light source 85 is the amount of beam generators 70. The light source 95 comprises four beam generators 70 for respectively outputting light beams 76 to a first optical plane 102, a second optical plane 104, a third optical plane 106, and a fourth optical plane 108 of the prism 100. The four light beams 76 are totally reflected in the prism 100 and then are collected into an enhanced light beam after leaving the prism 100 through a fifth optical plane 110 of the prism 100. Furthermore, the fifth optical plane 110 is positioned toward the light pipe of the projector to receive the light from the light source 95.

It is noted that the amount of beam generators 70 of the light source and the shape of the prisms in above embodiments should not be construed as limiting the present invention. The present invention can be applied to other applications that use a plurality of beams generators 70 for enhancing brightness of projection images and a prism for collecting light beams by total reflection.

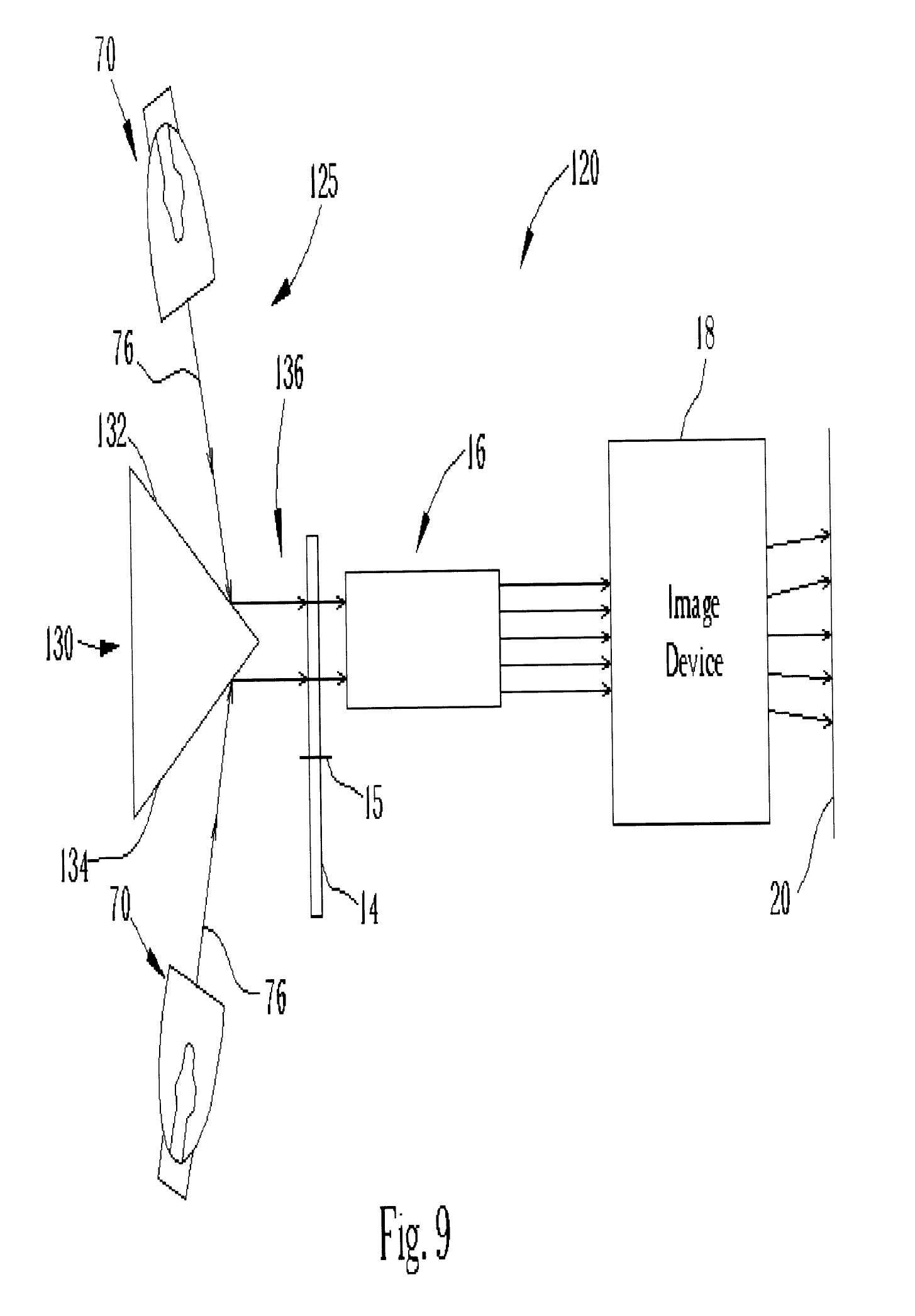

Please refer to FIG. 9, which is a schematic diagram of a projector 120 using a fourth embodiment light source 125 according to the present invention. The only difference between the projector 120 and the projector 30 is that the light source 125 replaces the light source 50 to provide light to the projector 120. The light source 125 comprises a prism 130 for reflecting light and two beam generators 70 for generating light beams 76. The two light beams 76 are respectively reflected at a first optical plane 132 and a second optical plane 134 of the prism 130, and then are collected into an enhanced light beam 136. The enhanced light beam 136 passes through the color wheel 14 into the light pipe 16, and then is inputted to the image device 18 after being uniformized by the light pipe 16.

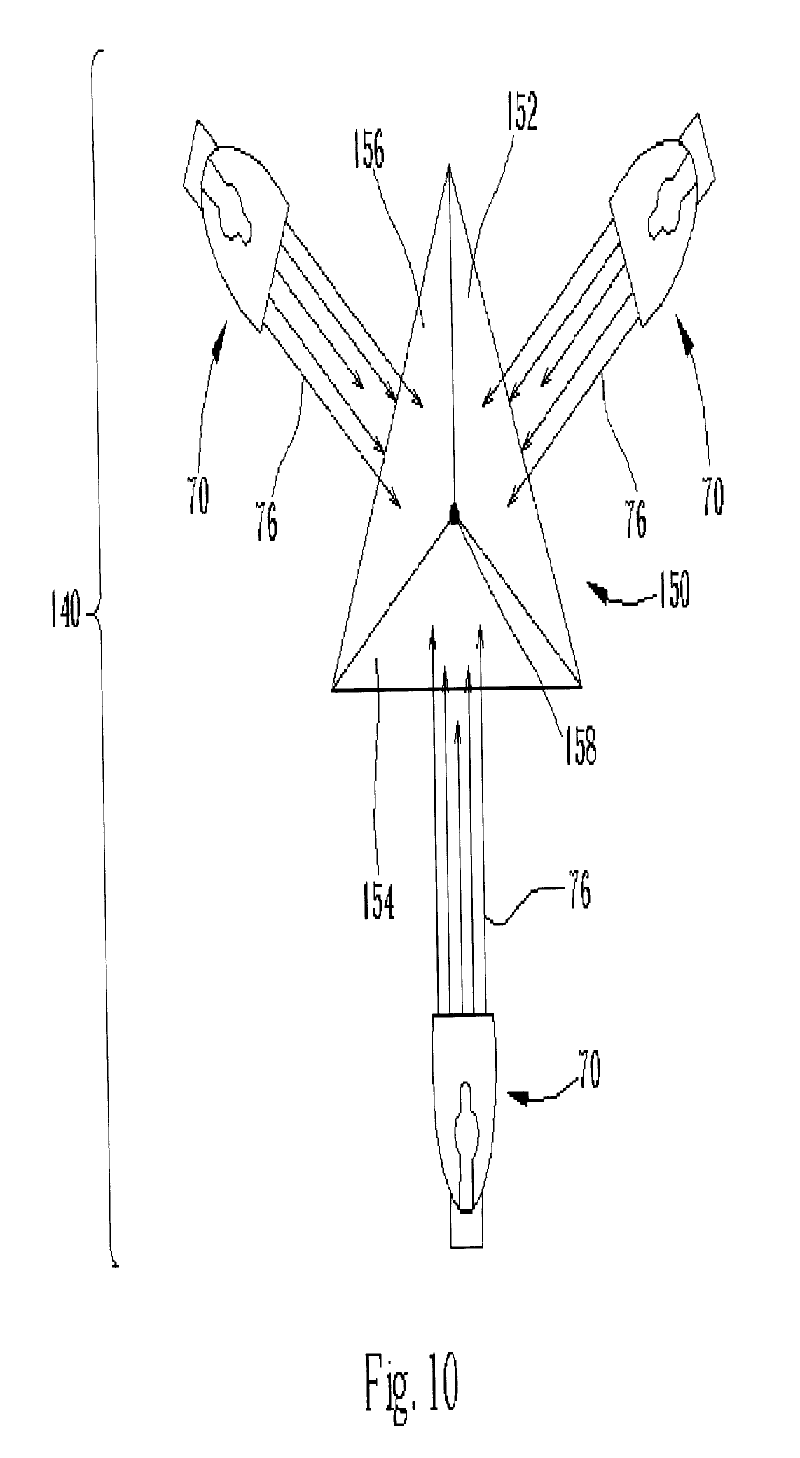

Please refer to FIG. 10, which is a schematic diagram of a fifth embodiment light source 140 according to the present invention. Similar to the light source 130, the light source 140 is used to provide light to a projector. The main differences between the two light sources 130 and 140 are the shape of their prisms and the amount of beam generators 70. The shape of the prism 150 of the light source 140 is the same as the shape of the prism 90 shown in FIG. 6. The prism 150 comprises three optical planes for reflecting light: a first optical plane 152, a second optical plane 154, and a third optical plane 156. The three optical planes 152, 154, and 156 connected to each other at an apex 158, and the prism 150 is positioned in the projector such that the apex 158 faces toward the light pipe of the projector. The light source 140 further comprises three beam generators 70 for generating three light beams 76 and respectively projecting the three light beams 76 to the first optical plane 152, the second optical plane 154, and the third optical plane 156. Finally, the three light beams 76 are reflected at the first optical plane 152, the second optical plane 154, and the third optical plane 156 to be collected and inputted to the light pipe of the projector.

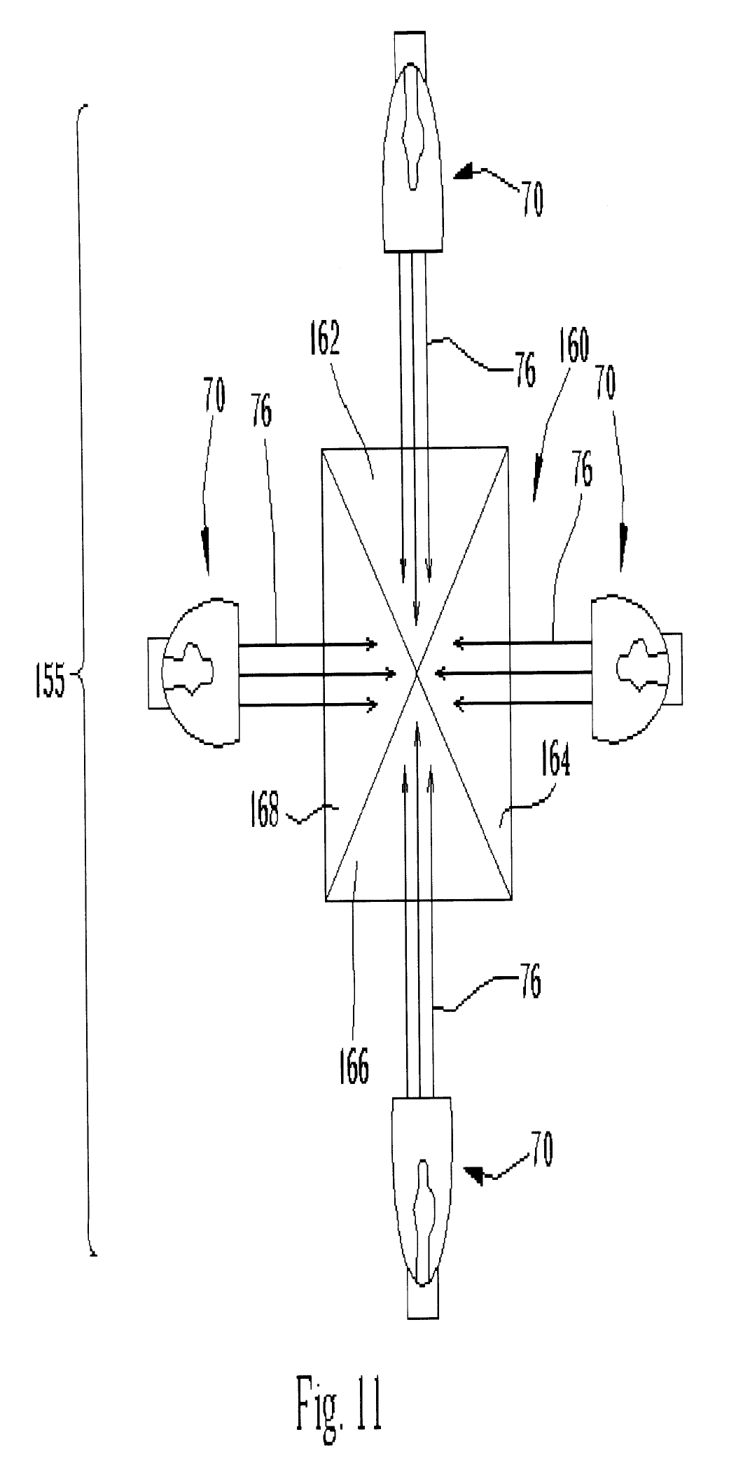

Please refer to FIG. 11, which is a schematic diagram of a sixth embodiment light source 155 according to the present invention. The difference between the two light sources 155 and 140 is the amount of beam generators 70. The light source 150 comprises four beam generators 70. The four light beams 76 generated by the four beam generators 70 are respectively projected to a first optical plane 162, a second optical plane 164, a third optical plane 166, and a fourth optical plane 168 of a prism 160 of the light source 155. Finally, the four light beams 76 are reflected at the first optical plane 162, the second optical plane 164, the third optical plane 166, and the fourth optical plane 168 to be collected and inputted to the light pipe of the projector.

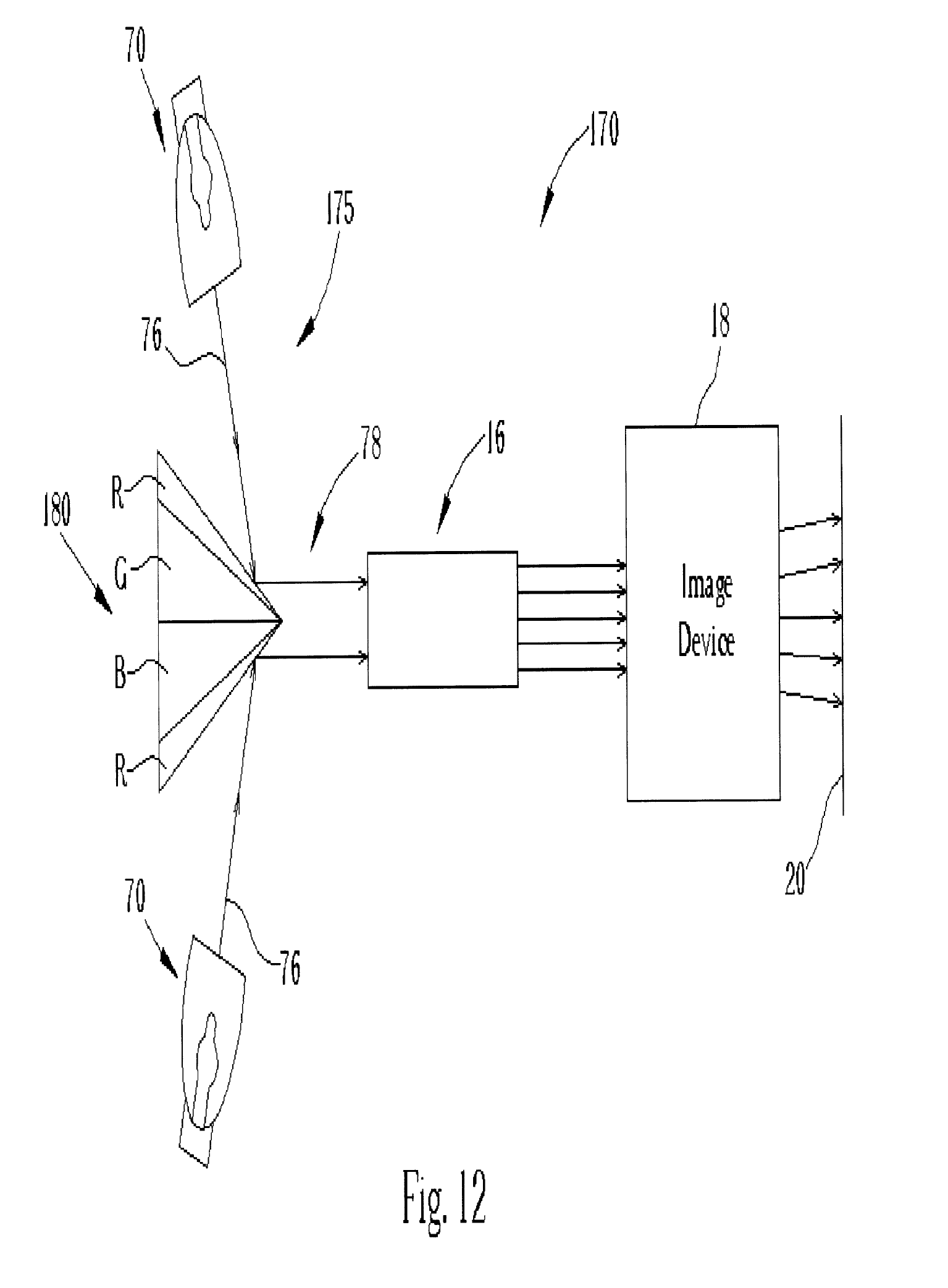

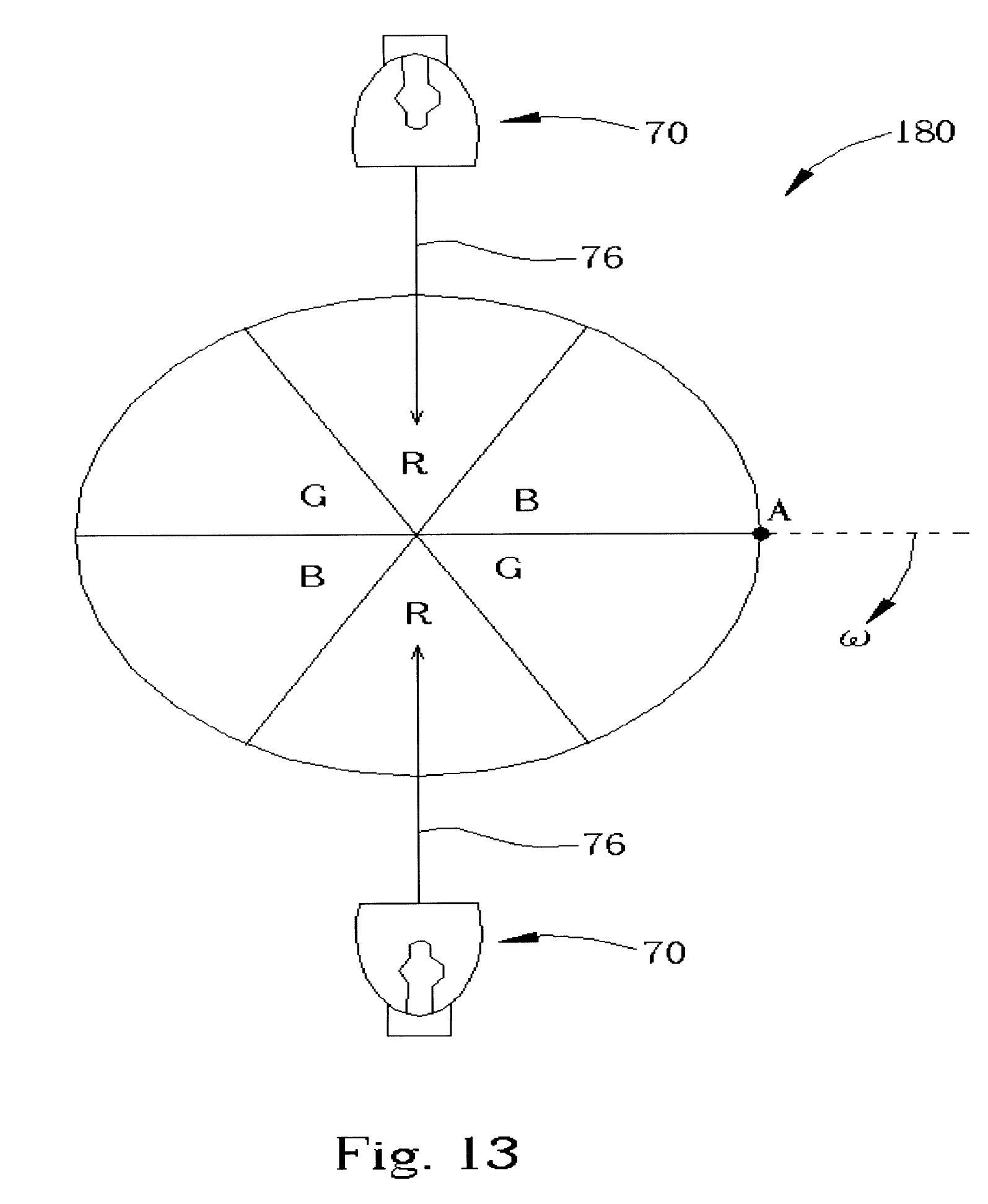

Please refer to FIG. 12 and FIG. 13. FIG. 12 is a schematic diagram of a projector 170 using a seventh embodiment light source 175 according the present invention. FIG. 13 is a schematic diagram of the light source 175. The main difference between the two projectors 170 and 120 is that the light source 175 replaces both the light source 125 and the color wheel 14 to provide light to the projector and to filter light. The light source 175 comprises a prism 180 for reflecting light and two beam generators 70. The prism 180 is placed in the projector 170 in a rotatable manner and comprises two first reflective filtering areas R, two second reflective filtering areas G, and two third reflective filtering areas B. Each of the reflective filtering areas R, G, and B is used for filtering and reflecting light. The first reflective filtering areas R filter the red light out of the light beams 76 and reflect the red light. The second reflective filtering areas G filter the green light out of the light beams 76 and reflect the green light. The third reflective filtering areas B filter the blue light out of the light beams 76 and reflect the blue light. When the prism 180 rotates clockwise at an angular velocity w, the two light beams 76 illuminate two of the reflective filtering areas R, G, or B that have the same filtration characteristic. Then, the two light beams 76 are filtered and reflected by the reflective filtering areas R, G, or B and are collected to form an enhanced light beam 76 which is projected to the light pipe 16. Finally, the image device 18 can process the enhanced light beam 76 to form an image beam.

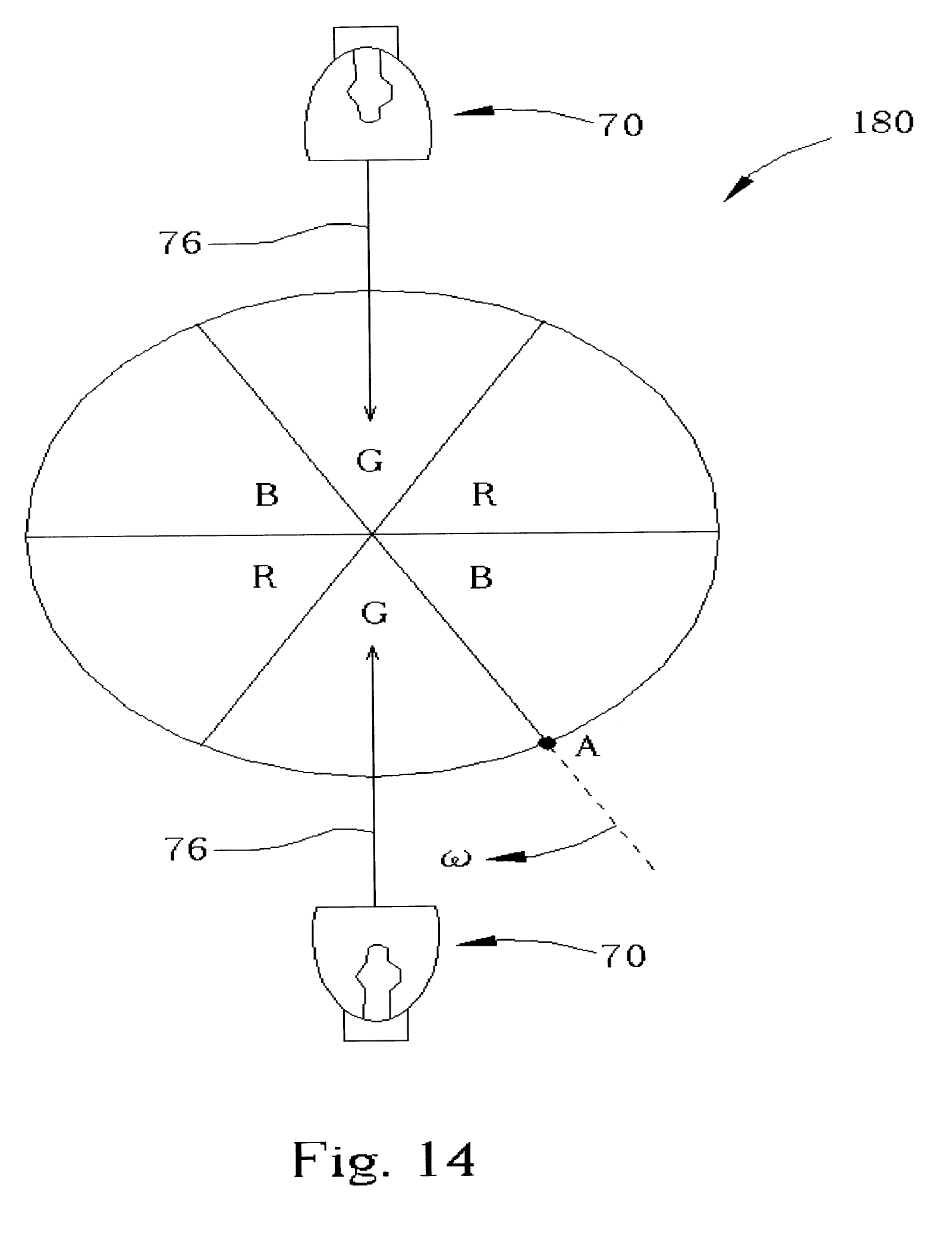

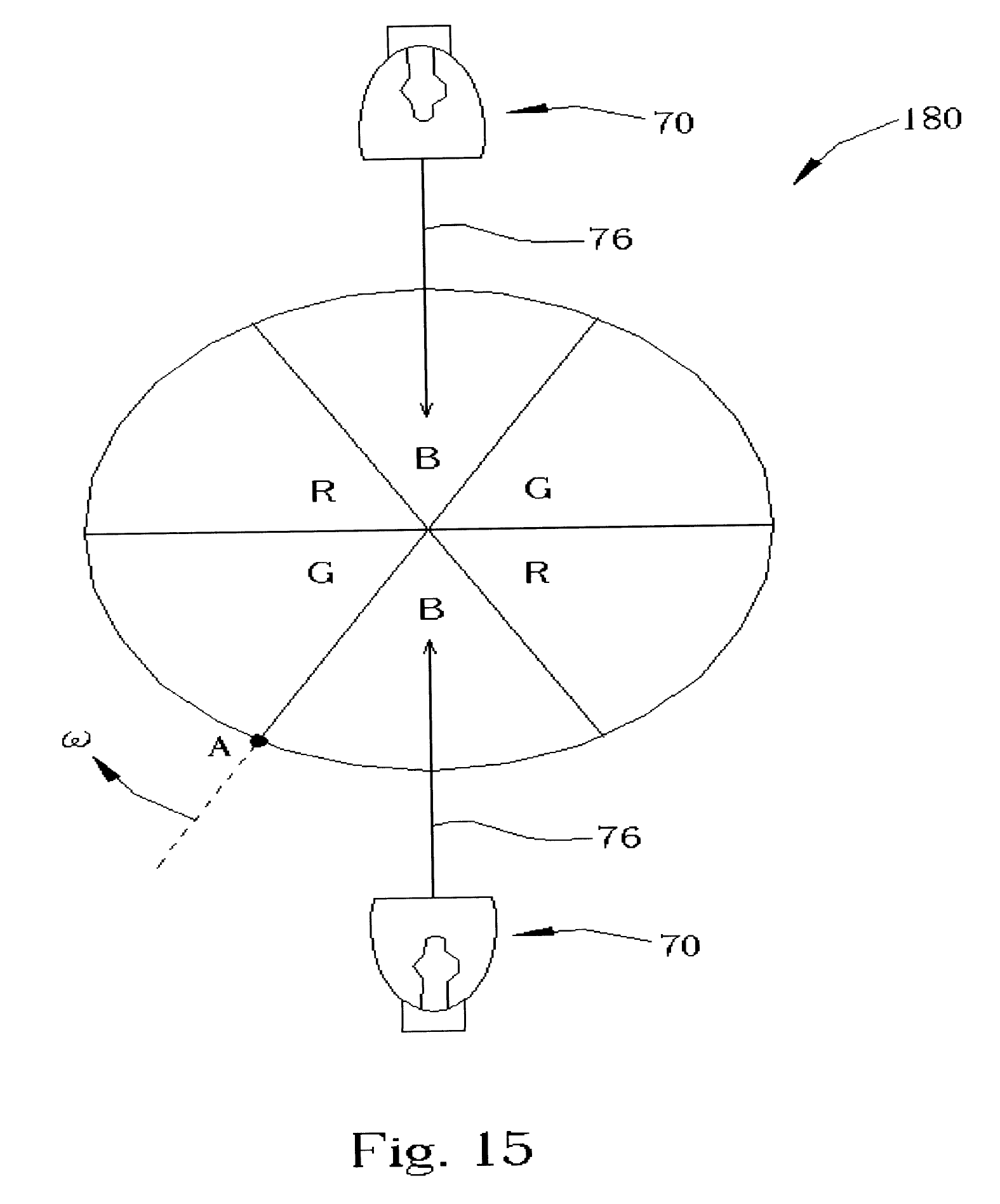

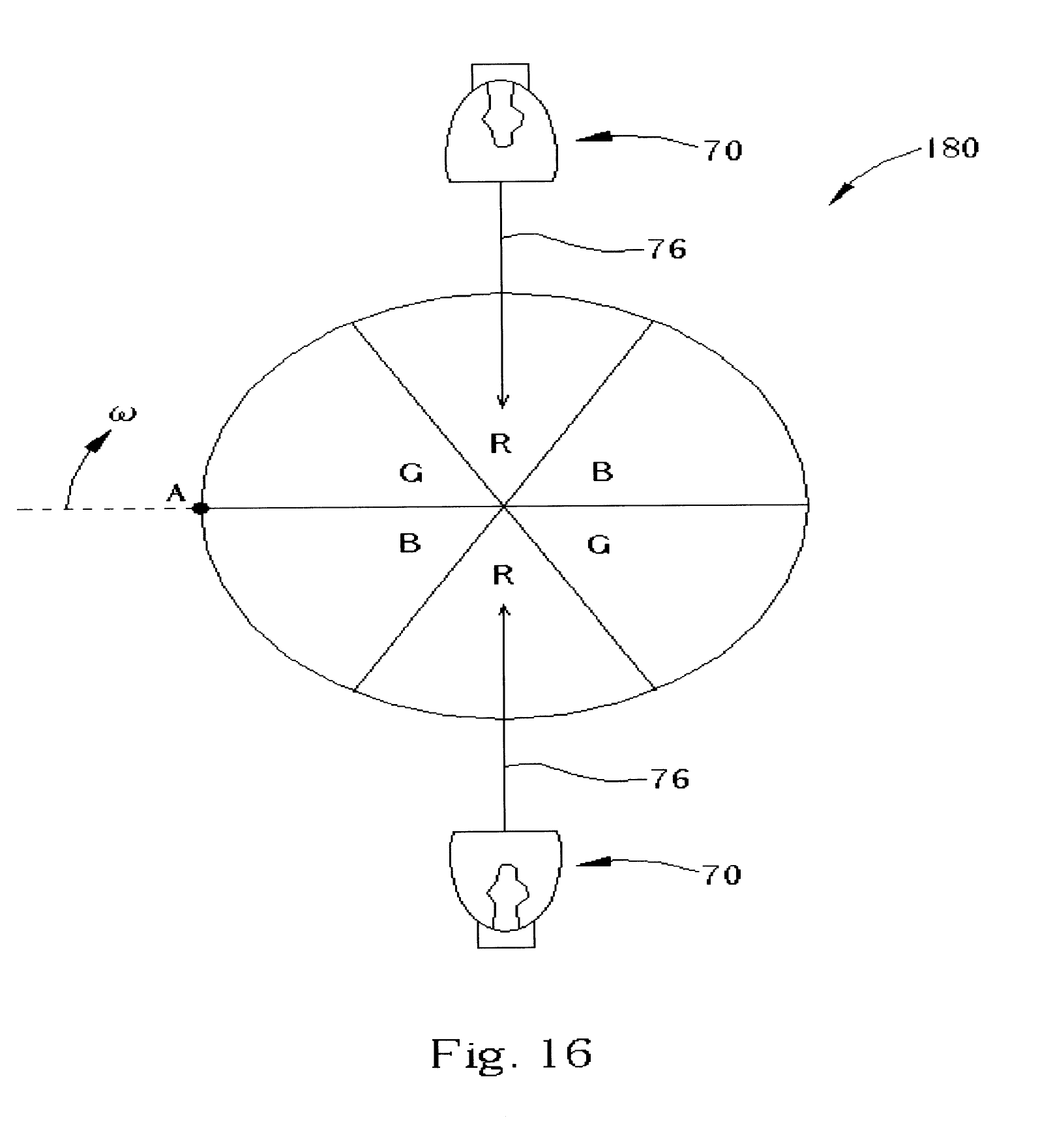

The operations of the light source 175 are described in detail referencing FIG. 13 to FIG. 16. FIG. 14 is a schematic diagram of the prism 180 when rotated by 60 degrees. FIG. 15 is a schematic diagram of the prism 180 when rotated by 120 degrees. FIG. 16 is a schematic diagram of the prism 180 when rotated by 180 degrees. As previously mentioned, the prism 180 rotates clockwise at an angular velocity ω. When the prism 180 rotates to 0 degrees as shown in FIG. 13, the two light beams 76 are projected to the first reflective filtering areas R so that the enhanced light beam 76 is a red monochromatic light beam. When the prism 180 rotates to 60 degrees as shown in FIG. 14, the two light beams 76 are projected to the second reflective filtering areas G so that the enhanced light beam 76 is a green monochromatic light beam. When the prism 180 rotates to 120 degrees as shown in FIG. 15, the two light beams 76 are projected to the third reflective filtering areas B so that the enhanced light beam 76 is a blue monochromatic light beam. When the prism 180 rotates to 180 degrees as shown in FIG. 16, the two light beams 76 are projected to the first reflective filtering areas R again. Therefore, the light source 175 periodically outputs the red, green, and blue enhanced light beams at a period (180°/ω).

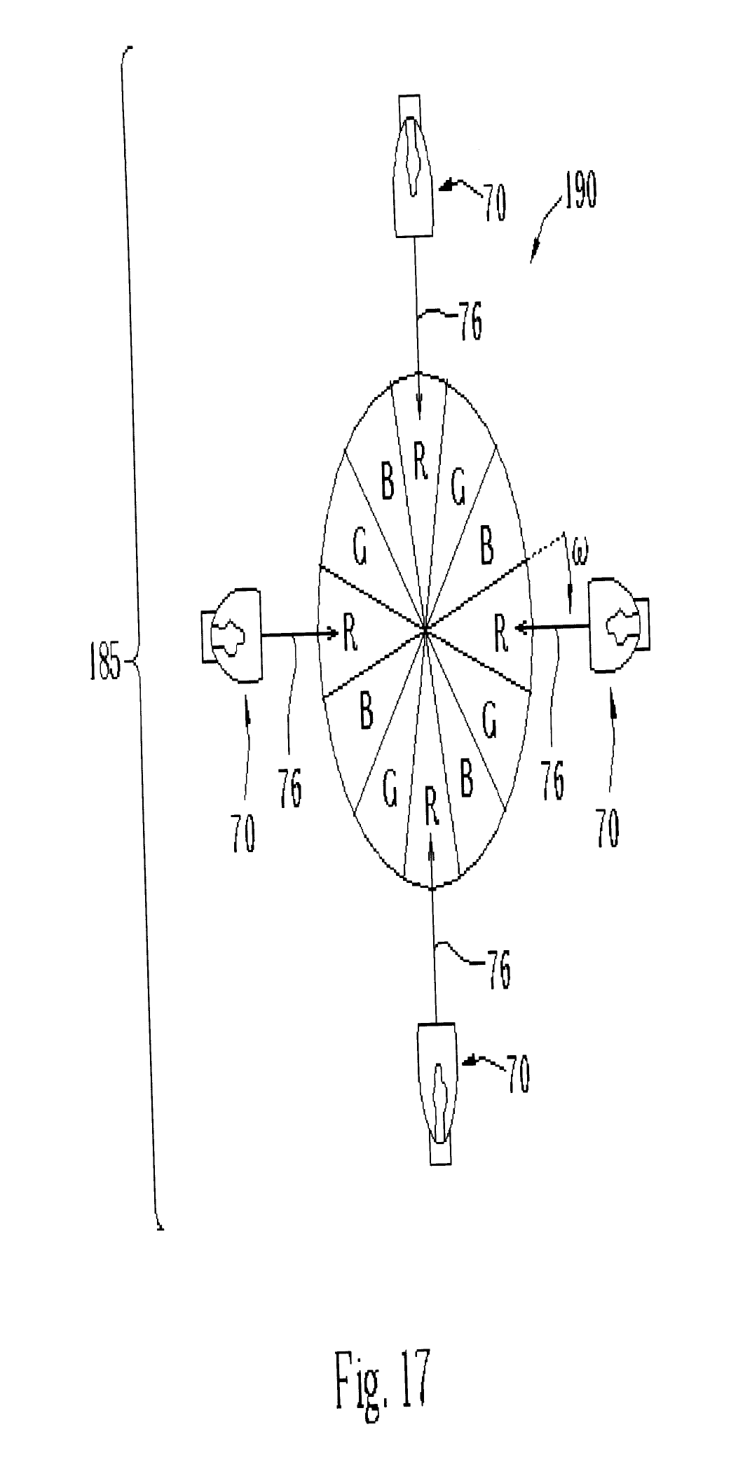

Please refer to FIG. 17, which is a schematic diagram of an eighth embodiment light source 185 according to the present invention. The operations of the light source 185 are very similar with the operations of the light source 175. The main differences between the two light sources 175 and 185 are the amount of beam generators 70 and the amount of the reflective filtering areas of the prisms. The light source 185 comprises four of the light beam generators 70 and a prism 190. The prism 190 comprises four first reflective filtering areas R, four second reflective filtering areas G, and four third reflective filtering areas B shown as FIG. 17. The prism 190 rotates clockwise at an angular velocity ω so that the light beams 76 are projected to four of the reflective filtering areas R, G, or B that have the same filtration characteristic. Therefore, the light source 185 outputs red, green, and blue monochromatic light beams by turning.

It is noted that the amount of reflective filtering areas in the above embodiments should not be construed as limiting the present invention. The present invention can be applied to other applications that use a plurality of the beams generators 70 for enhancing projection images and a prism for collecting light beams by reflection.

In contrast to the prior art, the present invention provides a light source that has a plurality of beam generators for generating light beams and a prism for collecting the light beams by reflection or refraction to form an enhanced light beam. Therefore, a projector comprising the light source according to the present invention can project images having greater brightness than other prior art projectors. In addition, the prism can comprises a plurality of reflective filtering areas for filtering and reflecting light to output red, green, and blue monochromatic light beams by turning so that a color wheel of the projector can be omitted to effectively use the limited space inside the projector.

Those skilled in the art will readily observe that numerous modifications and alterations of the device may be made while retaining the teachings of the invention. Accordingly, the above disclosure should be construed as limited only by the metes and bounds of the appended claims.

1. A light source comprising:
a prism having a plurality of optical planes for redirecting light; and
a plurality of beam generators for generating light beams and projecting the light beams to the optical planes;
wherein the optical planes redirect the light beams to collect the light beams to form an enhanced light beam.

2. The light source of claim 1 wherein the optical planes reflect the light beams to form the enhanced light beam.

3. The light source of claim 2 wherein total reflection of the light beams occurs at the optical planes, the light beams being collected to form the enhanced light beam after the total reflections.

4. The light source of claim 3 wherein the light beams enter the prism with a first refraction, and then leave the prism with a second refraction after the total reflection in the prism.

5. The light source of claim 3 wherein each of the beam generators corresponds to one of the optical planes, and each of the light beams is totally reflected at the corresponding optical plane.

6. The light source of claim 5 comprising two of the beam generators and the prism comprising three of the optical planes: a first optical plane, a second optical plane, and a third optical plane; wherein the light beams generated by the two beam generators are respectively totally reflected at the first optical plane and the second optical plane, and then leave the prism through the third optical plane.

7. The light source of claim 5 comprising three of the beam generators and the prism comprising four of the optical planes: a first optical plane, a second optical plane, a third optical plane, and a fourth optical plane;
wherein the light beams generated by the three beam generators are respectively totally reflected at the first optical plane, the second optical plane, and the third optical plane, and then leave the prism through the fourth optical plane.

8. The light source of claim 5 comprising four of the beam generators and the prism comprising five of the optical planes: a first optical plane, a second optical plane, a third optical plane, a fourth optical plane, and a fifth optical plane; wherein the light beams generated by the four beam generators are respectively totally reflected at the first optical plane, the second optical plane, the third optical plane, and the fourth optical plane, and then leave the prism through the fifth optical plane.

9. The light source of claim 2 wherein the prism is placed in a rotatable manner and further comprises:
a plurality of first reflective filtering areas for filtering and reflecting light, where the light beams are filtered and reflected by the first reflective filtering areas when the prism rotates to a first angle;
a plurality of second reflective filtering areas for filtering and reflecting light, where the light beams are filtered and reflected by the second reflective filtering areas when the prism rotates to a second angle; and
a plurality of third reflective filtering areas for filtering and reflecting light, where the light beams are filtered and reflected by the third reflective filtering areas when the prism rotates to a third angle.

10. The light source of claim 2 wherein each of the beam generators corresponds to one of the optical planes, and each of the light beams is reflected at the corresponding optical plane.

11. The light source of claim 10 comprising three of the beam generators and the prism comprising three of the optical planes, wherein the light beams generated by the three beam generators are reflected at the corresponding optical planes and then collected to form the enhanced light beam.

12. The light source of claim 10 comprising four of the beam generators and the prism comprising four of the optical planes, wherein the light beams generated by the four beam generators are reflected at the corresponding optical planes and then collected to form the enhanced light beam.

13. The light source of claim 1 being installed in a projector and being used to provide light to the projector,
wherein the projector comprises:
a light pipe for uniformizing light received from the light source; and
an image device for processing the uniformized light from the light pipe and for projecting the processed light to form an image, wherein the light pipe is positioned between the prism and the image device.

14. The light source of claim 13 wherein the projector further comprises a color wheel located between the prism and the light pipe for filtering the enhanced light beam so as to output beams with different colors by turning.

15. The light source of claim 1 wherein each of the beam generators comprises:
a light device for radiating light; and
a light collector for collecting the light radiated from the light device to form the light beam.

16. A projector comprising:
a light source having a prism and a plurality of beam generators, wherein the prism having a plurality of optical planes, the plurality of beam generators being used for generating light beams and projecting the light beams to the optical planes, the optical planes redirecting the light beams to collect the light beams to form an enhanced light beam;
a light pipe for uniformizing the enhanced light beam received from the light source; and
an image device for processing the uniformized light from the light pipe and for projecting the processed light to form an image;
wherein the light pipe is positioned between the prism and the image device.

17. The projector of claim 16 further comprising a color wheel located between the prism and the light pipe for filtering the enhanced light beam so as to output beams with different colors by turning.

18. The projector of claim 16 wherein the optical planes reflect the light beams to form the enhanced light beam.

19. The projector of claim 18 wherein total reflection of the light beams occurs at the optical planes, the light beams being collected to form the enhanced light beam after the total reflections.

20. The projector of claim 18 wherein the prism is placed in a rotatable manner and further comprises:
a plurality of first reflective filtering areas for filtering and reflecting light, where the light beams are filtered and reflected by the first reflective filtering areas when the prism rotates to a first angle;
a plurality of second reflective filtering areas for filtering and reflecting light, where the light beams are filtered and reflected by the second reflective filtering areas when the prism rotates to a second angle; and
a plurality of third reflective filtering areas for filtering and reflecting light, where the light beams are filtered and reflected by the third reflective filtering areas when the prism rotates to a third angle.
